(19) United States
(12) Patent Application Publication
(10) Pub. No.: US 2025/0343222 A1
(43) Pub. Date: Nov. 6, 2025

(54) POSITIVE ELECTRODE FOR NON-AQUEOUS ELECTROLYTE SECONDARY BATTERY, NON-AQUEOUS ELECTROLYTE SECONDARY BATTERY, BATTERY MODULE, AND BATTERY SYSTEM USING SAME, AND METHOD FOR MANUFACTURING POSITIVE ELECTRODE FOR NON-AQUEOUS ELECTROLYTE SECONDARY BATTERY

(71) Applicant: SEKISUI CHEMICAL CO., LTD., Osaka (JP)

(72) Inventors: Hikaru YOSHIKAWA, Tsukuba-shi (JP); Junnosuke AKIIKE, Tsukuba-shi (JP)

(73) Assignee: SEKISUI CHEMICAL CO., LTD., Osaka (JP)

(21) Appl. No.: 18/876,833

(22) PCT Filed: Jun. 21, 2023
(86) PCT No.: PCT/JP2023/023018

§ 371 Date: Dec. 19, 2024

(30) Foreign Application Priority Data
Jun. 21, 2022 (JP) 2022-099460

(51) Int. Cl. H01M 4/131; H01M 4/02; H01M 4/04; H01M 4/1391; H01M 4/36; H01M 4/58; H01M 4/62; H01M 10/052

(52) U.S. Cl. CPC H01M 4/131; H01M 4/0404; H01M 4/1391; H01M 4/366; H01M 4/5825; H01M 4/625; H01M 10/052; H01M 2004/028

(57) ABSTRACT

A positive electrode for a non-aqueous electrolyte secondary battery, including: a positive electrode current collector having a positive electrode current collector main body formed of a metal material; and a positive electrode active material layer provided on the positive electrode current collector, wherein: the positive electrode active material layer includes a positive electrode active material and an conducting agent, or the positive electrode active material layer includes a positive electrode active material and does not include a conducting agent; one or both of the positive electrode current collector and the positive electrode active material layer includes conductive carbon; the conductive carbon includes amorphous carbon; and the conductive carbon is present in an amount of 0.5 to 3.5% by mass with respect to a mass of the positive electrode excluding the positive electrode current collector main body.

### TECHNICAL FIELD

The present invention relates to a positive electrode for a non-aqueous electrolyte secondary battery, as well as a non-aqueous electrolyte secondary battery, a battery module, and a battery system, each using the positive electrode, and also relates to a method for producing a positive electrode for a non-aqueous electrolyte secondary battery.

Priority is claimed on Japanese Patent Application No. 2022-099460, filed Jun. 21, 2022, the contents of which are incorporated herein by reference.

### BACKGROUND ART

A non-aqueous electrolyte secondary battery is generally composed of a positive electrode, a non-aqueous electrolyte, a negative electrode, and a separation membrane (hereinafter, also referred to as “separator”) installed between the positive electrode and the negative electrode.

A conventionally known positive electrode for a non-aqueous electrolyte secondary battery is formed by fixing a composition composed of a positive electrode active material containing lithium ions, a conducting agent, and a binder to the surface of a metal foil as a current collector. Examples of the practically used positive electrode active material containing lithium ions include lithium transition metal composite oxides such as lithium cobalt oxide, lithium nickel oxide, and lithium manganese oxide, and lithium phosphate compounds such as lithium iron phosphate.

Patent Document 1 does not describe the production conditions for the positive electrode material. In this patent document, a relatively large amount of carbon, i.e., 5 parts by mass relative to 90 parts by mass of the positive electrode active material particles, is compounded into the positive electrode material; therefore, the resulting electrode mixture layer is presumed to contain carbon particles attached to the surface of the positive electrode active material particles and independent carbon particles. Further, in Patent Document 1, the thickness of the coating layer on the metal foil is not described, and the adequate amount of carbon in the entire positive electrode is not taken into consideration.

Patent Document 2 discloses a positive electrode active material whose surface is coated with graphene. However, Patent Document 2 does not describe the deterioration that occurs when charging and discharging are performed multiple times, or the effects of use or storage at high temperatures.

Patent Document 3 describes, as Example 4, a manufacturing method using acetylene black as a coating material for a positive electrode active material, and an evaluation result showing that an improved discharge rate performance was achieved by a battery constructed using a positive electrode prepared by mixing the obtained active material with acetylene black as a conducting agent and PVdF as a binder in a mass ratio of 7:2:1. However, in Patent Document 3, the electrode mixture layer contains 20% of a conducting agent and, hence, many independent carbon particles are presumed to be present in the layer. Patent Document 3 does not describe the amount of carbon required for the entire positive electrode, the state of the carbon in the part coating the active material, and its effects, and does not describe the deterioration that occurs when charging and discharging are performed multiple times, or the effects of use or storage at high temperatures.

Patent Document 4 discloses a positive electrode active material whose surface is coated with amorphous carbon, a method for producing a positive electrode using the same, a battery, etc. With regard to the material composition in the positive electrode active material layer, Patent Document 4 describes only a configuration including a positive electrode active material, a conducting agent, and a binder in a weight ratio of 90:5:5, wherein many independent carbon particles are presumed to be present. Patent Document 4 does not describe the amount of carbon required for the entire positive electrode, the state of the carbon in the part coating the active material, and its effects, and does not describe the deterioration that occurs when charging and discharging are performed multiple times, or the effects of use or storage at high temperatures.

Patent Document 5 discloses a positive electrode active material whose surface is coated with amorphous carbon, a method for producing a positive electrode using the same, a battery, etc. With regard to the material composition in the positive electrode active material layer, Patent Document 5 only describes that 2.4 g of positive electrode active material and 0.6 g of conducting agent are mixed, and many independent carbon particles are presumed to be present in the layer. Patent Document 5 does not describe the amount of carbon required for the entire positive electrode, the state of the carbon in the part coating the active material, and its effects, and does not describe the deterioration that occurs when charging and discharging are performed multiple times, or the effects of use or storage at high temperatures.

### PRIOR ART DOCUMENT

### Patent Document

Patent Document 1: International Patent Application Publication No. 2013/005739
Patent Document 2: Japanese Patent Granted Publication No. 5997890
Patent Document 3: Japanese Patent Granted Publication No. 5155498
Patent Document 4: Japanese Patent Granted Publication No. 5966093
Patent Document 5: International Patent Application Publication No. 2020/105695

### SUMMARY OF THE INVENTION

### Problems to be Solved by the Invention

The methods described in Patent Documents 1 to 5 are not necessarily satisfactory, and further improvement of battery performance is required.

The present invention provides a positive electrode for a non-aqueous electrolyte secondary battery, which can improve the performance of a non-aqueous electrolyte secondary battery in respect of high-rate cycling performance at high temperatures.

### Means for Solving the Problems

The present inventors have found that the high-rate cycling performance (or battery performance) at high temperatures can be improved by adjusting the amount of conductive carbon in the entire positive electrode within a specific range, and adjusting the crystal condition at the surface.

The embodiments of the present invention are as follows.
[1] A positive electrode for a non-aqueous electrolyte secondary battery, including: a positive electrode current collector having a positive electrode current collector main body formed of a metal material; and a positive electrode active material layer provided on the positive electrode current collector,
   wherein: the positive electrode active material layer comprises a positive electrode active material and a conducting agent;
   one or both of the positive electrode current collector and the positive electrode active material layer includes conductive carbon; the conductive carbon includes amorphous carbon; and the conductive carbon is present in an amount of 0.5 to 3.5% by mass with respect to a mass of the positive electrode excluding the positive electrode current collector main body.
[2] The positive electrode according to [1], wherein the positive electrode active material has, on at least a part of its surface, an active material coating section.
[2-1] The positive electrode according to [1] or [2], wherein an amount of the conducting agent in the positive electrode active material layer is less than 1 part by mass per 100 parts by mass of the positive electrode active material.
[2-2] The positive electrode according to [1] or [2], wherein an content of the conducting agent in the positive electrode active material layer is 0.5 parts by mass or less per 100 parts by mass of the positive electrode active material.
[3] A positive electrode for a non-aqueous electrolyte secondary battery, including: a positive electrode current collector having a positive electrode current collector main body formed of a metal material; and a positive electrode active material layer provided on the positive electrode current collector,
   wherein: the positive electrode active material layer includes a positive electrode active material and does not comprise a conductive agent; the positive electrode active material has, on at least a part of its surface, an active material coating section including a conductive material; one or both of the positive electrode current collector and the positive electrode active material layer includes conductive carbon;
   the conductive carbon includes amorphous carbon; and the conductive carbon is present in an amount of 0.5 to 3.5% by mass with respect to a mass of the positive electrode excluding the positive electrode current collector main body.
[4] The positive electrode according to any one of [2], [2-1], [2-2] and [3], wherein the amorphous carbon is present in the active material coating section at a higher proportion than crystalline carbon.
[5] The positive electrode according to [4], which has a resistance value of 10⁵ to 10⁹Ω as measured with respect to a surface of the positive electrode active material by a scanning spread resistance microscope.
[6] The positive electrode according to any one of [2], [2-1], [2-2] and [3], wherein the active material coating section comprises conductive carbon and has at least a region having a thickness of more than 3.4 to 100 nm.
[7] The positive electrode according to any one of [2]. [2-1], [2-2] and [3], wherein the active material coating section comprises conductive carbon and has at least a region having a thickness of 5 to 80 nm.
[8] The positive electrode according to any one of [2]. [2-1], [2-2] and [3], wherein the active material coating section comprises conductive carbon and has at least a region having a thickness of 10 to 50 nm.
[9] A positive electrode for a non-aqueous electrolyte secondary battery, including: a positive electrode current collector having a positive electrode current collector main body formed of a metal material; and a positive electrode active material layer provided on the positive electrode current collector,
   wherein: the positive electrode active material layer includes a positive electrode active material; and X is 0.5 to 3.5% by mass as determined by a measurement method A defined below with respect to a dried product, as a measurement target, obtained by removing whole of a layer present on the positive electrode current collector main body, collecting whole of substance resulting from the removed layer, and vacuum-drying the collected substance at 120° C.,
   wherein the measurement method A includes:
(1) taking a sample having a weight of w1 from a homogeneously mixed product of the measurement target, and subjecting the sample to thermogravimetry differential thermal analysis implemented by following step A1 and step A2 defined below, to determine a first weight loss amount M1 (unit: % by mass) and a second weight loss amount M2 (unit: % by mass, wherein:
   the step A1 is a step of raising a temperature of the sample from 30° C. to 600° C. at a heating rate of 10° C./min and holding the temperature at 600° C. for 10 minutes in an argon gas stream of 300 mL/min to measure a resulting mass w2 of the sample, from which a first weight loss amount M1 is determined by formula (a1):

$$M 1 = ( w 1 - w 2 ) / w 1 \times 100 ; \qquad ( a1 )$$

the step A2 is a step of, immediately after the step A1, lowering the temperature from 600° C. to 200° C. at a cooling rate of 10° C./min, holding the temperature at 200° C. for 10 minutes, followed by completely substituting the argon gas stream with an oxygen gas stream, raising the temperature from 200° C. to 1000° C. at a heating rate of 10° C./min in an oxygen gas stream of 100 mL/min, and holding the temperature at 1000° C. for 10 minutes in the same oxygen gas stream to measure a resulting mass w3 of the sample, from which a second weight loss amount M2 is calculated by formula (a2):

$$M 2 = ( w 1 - w 3 ) / w 1 \times 100 ; \qquad ( a2 )$$

(2) calculating X by formula (a3):

$$X = M 2 - M 1. \qquad ( a3 )$$

[10] A positive electrode for a non-aqueous electrolyte secondary battery, including: a positive electrode current collector having a positive electrode current collector main body formed of a metal material; and a positive electrode active material layer provided on the positive electrode current collector,
   wherein: the positive electrode active material layer includes a positive electrode active material; and Y is 0.5 to 3.5% by mass as determined by a measurement method B defined below with respect to a dried product, as a measurement target, obtained by removing whole of a layer present on the positive electrode current collector main body, collecting the whole of substance resulting from the removed layer, and vacuum-drying the collected substance at 120° C.,
   wherein the measurement method B includes:
(1) taking a sample having a weight of w1 from a homogeneously mixed product of the measurement target, and subjecting the sample to thermogravimetry differential thermal analysis implemented by following step A1 defined below, to determine a first weight loss amount M1 (unit: % by mass), wherein:
   the step A1 is a step of raising a temperature of the sample from 30° C. to 600° C. at a heating rate of 10° C./min and holding the temperature at 600° C. for 10 minutes in an argon gas stream of 300 mL/min to measure a resulting mass w2 of the sample, from which a first weight loss amount M1 is determined by formula (a1):

$$M 1 = ( w 1 - w2 ) / w 1 \times 100 ; \qquad ( a1 )$$

(2) homogeneously mixing the measurement target, and precisely weighing out 0.0001 mg of the measurement target to prepare a sample, which is then burned under burning conditions described below, to quantify generated carbon dioxide using a CHN elemental analyzer, thereby determining a total carbon amount M3 (unit: % by mass) relative to the sample, wherein
   the burning conditions are as follows:
   a combustion furnace temperature is 1150° C.,
   a reduction furnace temperature is 850° C.,
   a helium flow rate is 200 mL/min, and
   an oxygen flow rate is 25 to 30 mL/min; and
(3) calculating Y by formula (a4):

$$Y = M 3 - M 1. \qquad ( a4 )$$

[11] The positive electrode according to any one of [1] to (including [2-1] and [2-2]), wherein the positive electrode current collector main body has, on at least a part of its surface, a current collector coating layer having a thickness of 0.1 to 4.0 μm.
[12] The positive electrode according to any one of [1] to (including [2-1] and [2-2]), wherein the positive electrode active material layer comprises a binder.
[13] The positive electrode according to any one of [1] to (including [2-1] and [2-2]), wherein the positive electrode active material layer has a volume density of 2.00 to 2.80 g/cm³.
[13-1] The positive electrode according to any one of [1] to (including [2-1] and [2-2]), wherein the positive electrode active material layer has a volume density of 2.2 to 2.7 g/cm³.
[13-2] The positive electrode according to any one of [1] to (including [2-1] and [2-2]), wherein the positive electrode active material layer has a volume density of 2.3 to 2.6 g/cm³.
[14] The positive electrode active material according to any one of [I] to (including [2-1], [2-2], [13-1] and [13-2]), wherein the positive electrode active material includes a compound represented by a formula LiFe_{X}M₍₁₋ₓ₎PO₄, wherein 0≤x≤1, M is Co, Ni, Mn, Al, Ti or Zr.
[15] The positive electrode according to [14], wherein the positive electrode active material is lithium iron phosphate represented by LiFePO4.
[16] A non-aqueous electrolyte secondary battery, comprising the positive electrode of any one of [1] to (including [2-1], [2-2], [13-1] and [13-2]), a negative electrode, and a non-aqueous electrolyte disposed between the positive electrode and the negative electrode.
[17] The non-aqueous electrolyte secondary battery according to [16], which has a volumetric energy density of 260 Wh/L or more.
[18] A battery module or battery system including a plurality of the non-aqueous electrolyte secondary batteries of or [17].
[19] A method for producing the positive electrode of any one of [1] to (including [2-1], [2-2], [13-1] and [13-2]), including: a composition preparation step of preparing a positive electrode composition including the positive electrode active material, and a coating process of coating the positive electrode composition on the positive electrode current collector,
   wherein the composition preparation step prepares the positive electrode composition without mixing the positive electrode active material with any of a conducting agent and a compound capable of turning into a conducting agent after the coating step.

### Effect of the Invention

The present invention can provide a positive electrode for a non-aqueous electrolyte secondary battery, which can improve the performance of a non-aqueous electrolyte secondary battery in respect of high-rate cycling performance at high temperatures.

### BRIEF DESCRIPTION OF THE DRAWINGS

FIG. 1 is a cross-sectional view schematically showing an example of a positive electrode for a non-aqueous electrolyte secondary battery according to the present invention.

FIG. 2 is a cross-sectional view schematically showing an example of a non-aqueous electrolyte secondary battery according to the present invention.

FIG. 3 is a process diagram for explaining a method for measuring the peel strength of a positive electrode active material layer.

### EMBODIMENTS TO CARRY OUT THE INVENTION

In the present specification and claims. “to” indicating a numerical range means that the numerical values described before and after “to” are included as the lower limit and the upper limit of the range.

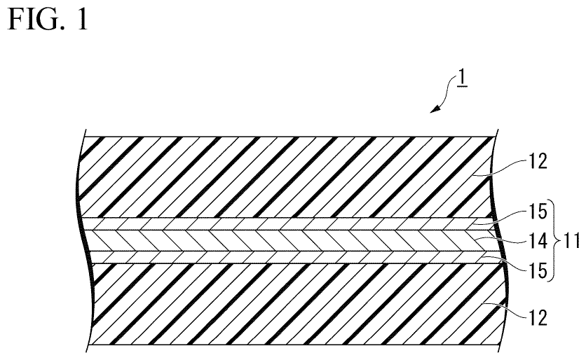

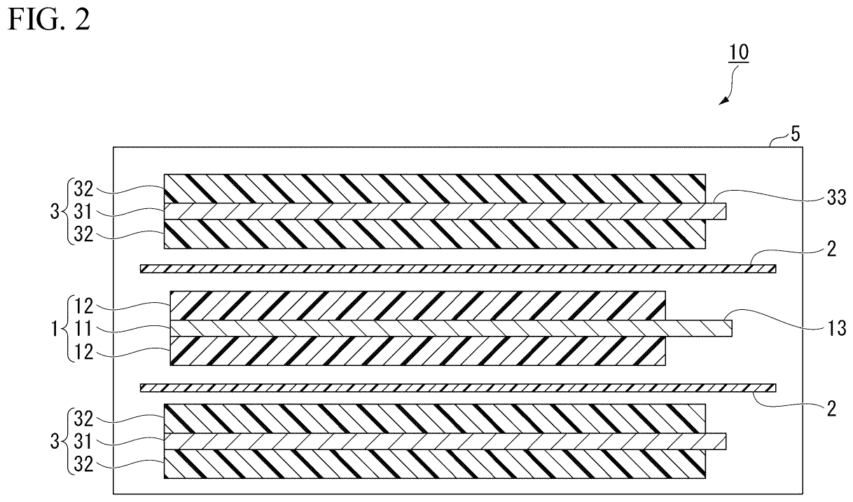

FIG. 1 is a schematic cross-sectional view showing one embodiment of the positive electrode of the present invention for a non-aqueous electrolyte secondary battery, and FIG. 2 is a schematic cross-sectional view showing one embodiment of the non-aqueous electrolyte secondary battery of the present invention.

FIG. 1 and FIG. 2 are schematic diagrams for facilitating the understanding of the configurations, and the dimensional ratios and the like of each component do not necessarily represent the actual ones.

### <Positive Electrode for Non-Aqueous Electrolyte Secondary Battery>

In the present embodiment, the positive electrode for a non-aqueous electrolyte secondary battery (also simply referred to as “positive electrode”) 1 has a positive electrode current collector 11 and a positive electrode active material layer 12.

The positive electrode active material layer 12 is present on at least one surface of the positive electrode current collector 11. The positive electrode active material layers 12 may be present on both sides of the positive electrode current collector 11.

In the example shown in FIG. 1, the positive electrode current collector 11 has a positive electrode current collector main body 14 and current collector coating layers 15 that cover the positive electrode current collector main body 14 on its surfaces facing the positive electrode active material layers 12. The positive electrode current collector main body 14 alone may be used as the positive electrode current collector 11.

### [Positive Electrode Active Material Layer]

The positive electrode active material layer 12 includes a positive electrode active material. The positive electrode active material layer 12 preferably further includes a binder. The positive electrode active material layer 12 may further include a conducting agent.

The shape of the positive electrode active material is preferably particulate.

The amount of the positive electrode active material is preferably 80.0 to 99.9% by mass, and more preferably 90 to 99.5% by mass, based on the total mass of the positive electrode active material layer 12.

The thickness of the positive electrode active material layer is preferably 30 to 500 μm, more preferably 40 to 400 μm, particularly preferably 50 to 300 μm. When the thickness of the positive electrode active material layer is not less than the lower limit value of the above range, the energy density of a battery with the positive electrode incorporated therein tends to improve. When the thickness is not more than the upper limit value of the above range, the peel strength of the positive electrode active material layer can be improved, thereby preventing delamination of the positive electrode active material layer during charging/discharging. When the positive electrode active material layers are present on both sides of the positive electrode current collector, the thickness of the positive electrode active material layer is the total thickness of the two layers located on both sides.

It is preferable that the positive electrode active material has, on at least a part of its surface, a coated section including a conductive material. It is more preferable that the entire surface of the positive electrode active material is coated with a conductive material for achieving more excellent battery capacity and cycling performance.

For example, the active material coating section is formed in advance on the surface of the positive electrode active material particles, and is present on the surface of the positive electrode active material particles in the positive electrode active material layer. That is, the active material coating section in the present specification is not one newly formed in the steps following the preparation step of a positive electrode composition. In addition, the active material coating section is not one that comes off in the steps following the preparation step of a positive electrode composition.

For example, the active material coating section stays on the surface of the core section of the positive electrode active material particles even when the coated particles are mixed with a solvent by a mixer or the like during the preparation of a positive electrode composition. Further, the active material coating section stays on the surface of the positive electrode active material even when the positive electrode active material layer is detached from the positive electrode and then put into a solvent to dissolve the binder contained in the positive electrode active material layer in the solvent. Furthermore, the active material coating section stays on the surface of the positive electrode active material even when an operation to disintegrate agglomerated particles is implemented for measuring the particle size distribution of the particles in the positive electrode active material layer by the laser diffraction scattering method.

The active material coating section of the active material particles preferably covers 50% or more, preferably 70% or more, and more preferably 90% or more of the total area of the entire outer surfaces of the positive electrode active material particles. That is, the coated particles have a core section that is a positive electrode active material and an coated section that covers the surface of the core section, and the area ratio (coverage) of the coated section with respect to the surface area of the core section is preferably 50% or more, more preferably 70% or more, and even more preferably 90% or more.

To determine the area of the active material coating section, the outer periphery of the positive electrode active material particle is subjected to elemental analysis by transmission electron microscope-energy dispersive X-ray spectroscopy (TEM-EDX) with respect to the particles in the positive electrode active material layer. The elemental analysis is performed on carbon to identify the carbon covering the positive electrode active material particles. A section with a carbon coating having a thickness of 1 nm or more is defined as a coating section, and the ratio of the coating section to the entire circumference of the observed positive electrode active material particle can be determined as the coverage. The measurement can be performed with respect to, for example, 10 positive electrode active material particles, and an average value thereof can be used as a value of the coverage.

With respect to the coverage of the positive electrode active material particles, the determination can also be implemented by calculation from TEM-EDX elemental mapping of particles with elements specific to the positive electrode active material and elements specific to the conductive material in the active material coating section of the active material. Similarly, a ratio of the active material coating section to the entire circumference of the observed positive electrode active material particle may be determined as the coverage, with the coating being defined as at least 1 nm-thick portion of the element specific to the conductive material. The measurement can be performed with respect to, for example, 10 positive electrode active material particles, and an average value thereof can be used as a value of the coverage.

The active material coating section is a layer directly formed on the surface of particles (core section) composed of only the positive electrode active material. The thickness of the active material coating section of the positive electrode active material is preferably more than 3.4 to 100 nm, more preferably 5 to 80 nm, even more preferably 10 to 50 nm.

The thickness of the coated section of the positive electrode active material can be measured by a method of measuring the thickness of the coated section in a transmission electron microscope (TEM) image of the positive electrode active material. The thickness of the coated section on the surface of the positive electrode active material need not be uniform. It is preferable that the positive electrode active material has, on at least a part of its surface, the coated section having a thickness of 1 nm or more, and the maximum thickness of the coated section is 100 nm or less.

In the present invention, the area ratio (coverage) of the coated section of the active material in the coated particles is particularly preferably 100% with respect to the surface area of the core section.

This ratio is an average value for all the positive electrode active material particles present in the positive electrode active material layer. As long as this average value is not less than the above lower limit value, the positive electrode active material layer may contain positive electrode active material particles without the active material coating section. When the positive electrode active material particles (single particles) without the coated section are present in the positive electrode active material layer, the amount thereof is preferably 30% by mass or less, more preferably 20% by mass or less, and particularly preferably 10% by mass or less, with respect to the total mass of the positive electrode active material particles present in the positive electrode active material layer.

The conductive material of the coated section of the active material preferably contains carbon (conductive carbon). The conductive material may be composed only of carbon, or may be a conductive organic compound containing carbon and elements other than carbon. Examples of the other elements include nitrogen, hydrogen, oxygen and the like. In the conductive organic compound, the amount of the other elements is preferably 10 atomic % or less, and more preferably 5 atomic % or less.

It is more preferable that the conductive material in the active material coating section is composed only of carbon.

The amount of the conductive material is 0.1 to 3.0% by mass, more preferably 0.5 to 1.5% by mass, even more preferably 0.7 to 1.3% by mass, based on the total mass of the positive electrode active material including the coated section. Excessive amount of the conductive material is not favorable in that the conductive material may come off the surface of the positive electrode active material and remain as independent conducting agent particles.

Conductive particles that do not contribute to the creation of conductive path may become a site where self-discharge of the battery starts or a cause of undesirable side reactions.

The conductive material of the active material coating section contains carbon (conductive carbon). The conductive material may be composed only of carbon, or may be a conductive organic compound containing carbon and elements other than carbon. Examples of the other elements include hydrogen, oxygen and the like. In the conductive organic compound, the amount of the other elements is preferably 10 atomic % or less, and more preferably 5 atomic % or less. It is more preferable that the conductive material in the active material coating section is composed only of carbon.

The amount of the conductive material is 0.1 to 4.0% by mass, more preferably 0.5 to 3.0% by mass, even more preferably 0.7 to 2.5% by mass, based on the total mass of the positive electrode active material including the coated section.

Excessive amount of the conductive material is not favorable in that the conductive material may come off the surface of the positive electrode active material particles and remain as isolated conducting agent particles. When the active material coating section is composed of carbon, it is preferable to adjust the resistivity of the active material surface to fall within the range of 10⁵ to 10⁹Ω. When the surface is coated with highly conductive carbon black (e.g., furnace black, channel black, acetylene black, thermal black, etc.), carbon nanotubes, graphene, etc., the resistivity becomes too low, which increases side reactivity with the electrolyte during charge/discharge cycles and unfavorably reduces the battery life performance. The resistivity of the active material surface can be measured, for example, using a scanning spread resistance microscope (SSRM).

The positive electrode active material preferably contains a compound having an olivine crystal structure.

The compound having an olivine crystal structure is preferably a compound represented by the following formula: LiFeₓM₍₁₋ₓ₎PO₄ (hereinafter, also referred to as “formula (I)”). In the formula (I), 0≤x≤1. M is Co, Ni, Mn, Al, Ti or Zr. A minute amount of Fe and M (Co, Ni, Mn, Al, Ti or Zr) may be replaced with another element so long as the replacement does not affect the physical properties of the compound. The presence of a trace amount of metal impurities in the compound represented by the formula (I) does not impair the effect of the present invention.

The compound represented by the formula (I) is preferably lithium iron phosphate represented by LiFePO₄ (hereinafter, also referred to as “lithium iron phosphate”). The compound is more preferably lithium iron phosphate particles each having, on at least a part of its surface, a coated section including a conductive material (hereinafter, also referred to as “coated lithium iron phosphate particles”). It is more preferable that the entire surface of lithium iron phosphate particles is coated with a conductive material for achieving more excellent battery capacity and cycling performance.

The coated lithium iron phosphate particles can be produced by a known method.

The manufacturing method for obtaining lithium iron phosphate particles coated with low-crystallinity carbon is not particularly limited, and examples thereof include a method in which a graphitizable resin or a non-graphitizable resin, naphthalene, coal tar, binder pitch, etc. is added as a precursor to the lithium iron phosphate particles and the resulting is heat-treated at 600 to 1300° C., and a method in which fluidized lithium iron phosphate particles are subjected to chemical vapor deposition (CVD) by heat treatment at 600 to 1300° C. using hydrocarbon compounds such as methanol, ethanol, benzene, and toluene as a chemical vapor deposition carbon source, to thereby form a carbon coating on the surface.

The positive electrode active material may contain other positive electrode active materials than the compound having an olivine type crystal structure. Preferable examples of the other positive electrode active materials include a lithium transition metal composite oxide. Specific examples thereof include lithium cobalt oxide, lithium nickel oxide, lithium nickel cobalt aluminum oxide (LiNiₓCo_{y}Al₂O₂ with the proviso that x+y+z=1), lithium nickel cobalt manganese oxide (LiNiₓCo_{y}Mn_{z}O₂ with the proviso that x+y+z=1), lithium manganese oxide, lithium manganese cobalt oxide, lithium manganese chromium oxide, lithium vanadium nickel oxide, nickel-substituted lithium manganese oxide (e.g., LiMn_{1.5}Ni_{0.5}O₄), and lithium vanadium cobalt oxide (LiCoVO₄), as well as nonstoichiometric compounds formed by partially substituting the compounds listed above with metal elements. Examples of the metal element include one or more selected from the group consisting of Mn, Mg, Ni, Co, Cu, Zn and Ge.

With respect to the other positive electrode active materials, a single type thereof may be used individually or two or more types thereof may be used in combination.

The other positive electrode active material may have, on at least a part of its surface, the coated section described above.

The amount of the compound having an olivine type crystal structure is preferably 50% by mass or more, preferably 80% by mass or more, and even more preferably 90% by mass or more, based on the total mass of the positive electrode active material (including the mass of the coated section if present). The amount of the compound having an olivine type crystal structure may be 100% by mass, based on the total mass of the positive electrode active material particles.

When the coated lithium iron phosphate particles are used, the amount of the coated lithium iron phosphate particles is preferably 50% by mass or more, more preferably 80% by mass or more, and even more preferably 90% by mass or more, based on the total mass of the positive electrode active material. This amount may be 100% by mass.

The carbon of the active material coating section can be formed by a known method.

When the active material coating section is formed of carbon, it is preferably amorphous carbon.

The manufacturing method for obtaining the positive electrode active material coated with amorphous carbon is not particularly limited, and examples thereof include a method in which a graphitizable resin or a non-graphitizable resin, naphthalene, coal tar, binder pitch, etc. is added as a precursor to the positive electrode active material particles and the resulting is heat-treated at 600 to 1300° C., and a known method in which fluidized lithium iron phosphate particles are subjected to chemical vapor deposition (CVD) by heat treatment at 600 to 1300° C. using hydrocarbon compounds such as methanol, ethanol, benzene, and toluene as a chemical vapor deposition carbon source, to thereby form a carbon coating on the surface. The majority of the carbon that constitutes the active material coating section formed by these methods is amorphous.

When the active material coating section is formed of carbon nanotubes. graphene, or the like, which are highly conductive and highly crystalline, instead of amorphous carbon, the resistance of the active material coating section becomes too low, and side reactions with the electrolyte solution increase during charge-discharge cycles, resulting in a decrease in the battery life.

For example, by checking the sp² bond ratio from the difference in the shape of the EELS spectrum (C-K edge), it is possible to determine whether the carbon in the active material coating section is crystalline or amorphous. Similarly, by checking the peak positions in the wavenumber range of 1200 cm⁻¹ to 1800 cm⁻¹ in the Raman spectrum, it is possible to determine whether the carbon in the active material coating section is crystalline or amorphous.

It is preferable that the proportion of amorphous carbon in the active material coating section is higher than the proportion of crystalline carbon. Specifically, the ratio of amorphous carbon to crystalline carbon in the active material coating section (amorphous carbon/crystalline carbon) is preferably 1.2 or more, more preferably 1.6 or more, particularly preferably 2.0 or more. Whether the carbon in the active material coating section is crystalline or amorphous can be determined by checking the sp² bond ratio from the difference in the shape of the EELS spectrum (C-K edge). For example, the EELS spectrum can be measured at 20 points on the surface of the positive electrode active material to determine the proportion of crystalline carbon and the proportion of amorphous carbon.

The resistance value of the active material coating section is preferably 10⁵ to 10⁹Ω. The resistance value of the active material coating section can be measured, for example, using a scanning spread resistance microscope (SSRM).

The average particle size of the positive electrode active material particles (that is, positive electrode active material powder) (including the thickness of the coated section if present) is, for example, preferably 0.1 to 20.0 μm, more preferably 0.2 to 10.0 μm. When two or more types of positive electrode active materials are used, the average particle size of each of such positive electrode active materials may be within the above range.

The average particle size of the positive electrode active material in the present specification is a volume-based median particle size measured using a laser diffraction/scattering particle size distribution analyzer.

The binder that can be contained in the positive electrode active material layer 12 is an organic substance, and examples thereof include polyacrylic acid, lithium polyacrylate, polyvinylidene fluoride, polyvinylidene fluoride-hexafluoropropylene copolymers, styrene butadiene rubbers, polyvinyl alcohol, polyvinyl acetal, polyethylene oxide, polyethylene glycol, carboxymethyl cellulose, polyacrylic nitrile, and polyimide. With respect to the binder, a single type thereof may be used alone or two or more types thereof may be used in combination.

The amount of the binder in the positive electrode active material layer 12 is, for example, preferably 4.0% by mass or less, more preferably 2.0% by mass or less, even more preferably 1.5% by mass or less, particularly preferably 1.0% by mass or less, based on the total mass of the positive electrode active material layer 12. When the amount of the binder is not more than the above upper limit value, the proportion of the substance that does not contribute to the conduction of lithium ions in the positive electrode active material layer 12 is reduced, and the battery performance can be further improved.

When the positive electrode active material layer 12 contains a binder, the lower limit of the amount of the binder is preferably 0.1% by mass or more, more preferably 0.5% by mass or more, based on the total mass of the positive electrode active material layer 12.

Examples of the conducting agent contained in the positive electrode active material layer 12 include carbon materials such as graphite, graphene, hard carbon, Ketjen black, acetylene black, and carbon nanotube. With respect to the conducting agent, a single type thereof may be used alone or two or more types thereof may be used in combination.

The amount of the conducting agent in the positive electrode active material layer 12 is, for example, preferably 4 parts by mass or less, more preferably 3 parts by mass or less, even more preferably 1 part by mass or less, even more preferably less than 1 part by mass, even more preferably 0.5 part by mass or less, relative to 100 parts by mass of the positive electrode active material. It is particularly preferable that the positive electrode active material layer does not contain a conducting agent, and it is desirable that there are no isolated conducting agent particles (for example, isolated carbon particles).

When the conducting agent is incorporated into the positive electrode active material layer 12, the lower limit value of the amount of the conducting agent is appropriately determined according to the type of the conducting agent, and is, for example, more than 0.1% by mass, based on the total mass of the positive electrode active material layer 12.

In the context of the present specification, the expression “the positive electrode active material layer 12 does not contain a conducting agent” or similar expression means that the positive electrode active material layer 12 does not substantially contain a conducting agent, and should not be construed as excluding a case where a conducting agent is contained in such an amount that the effects of the present invention are not affected. For example, if the amount of the conducting agent is 0.1% by mass or less, based on the total mass of the positive electrode active material layer 12, then, it is judged that substantially no conducting agent is contained.

Conducting agent particles that do not contribute to the creation of conductive path may become a site where self-discharge of the battery starts or a cause of undesirable side reactions.

### [Positive Electrode Current Collector]

The positive electrode current collector body 14 is formed of a metal material. Examples of the metal material include conductive metals such as copper, aluminum, titanium, nickel, and stainless steel.

The thickness of the positive electrode current collector main body 14 is preferably, for example, 8 to 40 μm, and more preferably 10 to 25 μm.

The thickness of the positive electrode current collector main body 14 and the thickness of the positive electrode current collector 11 can be measured using a micrometer. One example of the measuring instrument usable for this purpose is an instrument with the product name “MDH-25M”, manufactured by Mitutoyo Co., Ltd.

### [Current Collector Coating Layer]

It is preferable that the positive electrode current collector main body 14 has, on at least a part of its surface, a current collector coating layer 15. The current collector coating layer 15 contains a conductive material. The presence of the current collector coating layer further improves the effect of reducing the impedance of the non-aqueous electrolyte secondary battery.

The conductive material in the current collector coating layer 15 preferably contains carbon (conductive carbon). The conductive material is more preferably one composed only of carbon.

The current collector coating layer 15 is preferred to be, for example, a coating layer containing carbon particles such as carbon black and a binder. Examples of the binder for the current collector coating layer 15 include those listed above as examples of the binder for the positive electrode active material layer 12.

With regard to the production of the positive electrode current collector 11 in which the surface of the positive electrode current collector main body 14 is coated with the current collector coating layer 15, for example, the production can be implemented by a method in which a composition (i.e., composition for preparing the current collector coating layer) containing the conductive material, the binder, and a solvent is applied to the surface of the positive electrode current collector main body 14 with a known coating method such as a gravure method, followed by drying to remove the solvent.

The thickness of the current collector coating layer 15 is preferably 0.1 to 4.0 μm.

The thickness of the current collector coating layer can be measured by a method that measures the thickness of the coating layer in a transmission electron microscope (TEM) image or a scanning electron microscope (SEM) image of a cross section of the current collector coating layer. The thickness of the current collector coating layer need not be uniform. It is preferable that the current collector coating layer 15 having a thickness of 0.1 μm or more is present on at least a part of the surface of the positive electrode current collector main body 14, and the maximum thickness of the current collector coating layer is 4.0 μm or less.

In the present embodiment, one or both of the positive electrode current collector 11 and the positive electrode active material layer 12 include conductive carbon.

When the positive electrode active material layer 12 contains conductive carbon, it is preferable that at least one of the conductive material coating the positive electrode active material and the conducting agent contains the carbon.

When the positive electrode current collector 11 contains conductive carbon, it is preferable that the conductive material in the current collector coating layer 15 contains the carbon.

### First Embodiment

The positive electrode 1 of the present embodiment preferably has a conductive carbon content of 0.5 to 3.5% by mass, more preferably 0.8 to 3.0% by mass, even more preferably 1.0 to 1.5% by mass or more, with respect to the mass of the positive electrode 1 excluding the positive electrode current collector main body 14.

When the positive electrode 1 is composed of the positive electrode current collector main body 14 and the positive electrode active material layer 12, the mass of the positive electrode 1 excluding the positive electrode current collector main body 14 is the mass of the positive electrode active material layer 12.

When the positive electrode 1 is composed of the positive electrode current collector main body 14, the current collector coating layer 15, and the positive electrode active material layer 12, the mass of the positive electrode 1 excluding the positive electrode current collector main body 14 is the sum of the mass of the current collector coating layer 15 and the mass of the positive electrode active material layer 12.

When the amount of conductive carbon is not less than the lower limit value of the above range with respect to the mass of the positive electrode excluding the positive electrode current collector main body, an impedance reduction effect and a high capacity retention rate in a high-rate charge/discharge cycle under a high temperature environment are achieved. When the amount is not more than the upper limit value, excellent effect of improving the volumetric energy density is achieved.

The amount of the conductive carbon with respect to the mass of the positive electrode 1 excluding the positive electrode current collector main body 14 can be measured by <<Method for measuring conductive carbon content>> described below with respect to a dried product (powder), as a measurement target, obtained by detaching the whole of a layer present on the positive electrode current collector main body 14, collecting the whole of substance resulting from the detached layer, and vacuum-drying the collected substance at 120° C.

The conductive carbon to be measured by the <<Method for measuring conductive carbon content>> described below includes carbon in the coated section of the positive electrode active material, carbon in the conducting agent, and carbon in the current collector coating layer 15. Carbon in the binder is not included in the conductive carbon to be measured.

As a method for obtaining the measurement target, for example, the following method can be adopted.

First, the layer (powder) present on the positive electrode current collector main body 14 is completely detached by a method in which the positive electrode 1 is punched to obtain a piece having a predetermined size, and the piece of the positive electrode current collector main body 14 is immersed in a solvent (for example, N-methylpyrrolidone) and stirred. Next, after confirming that no powder remains attached to the positive electrode current collector main body 14, the positive electrode current collector main body 14 is taken out from the solvent to obtain a suspension (slurry) containing the detached powder and the solvent. The obtained suspension is dried at 120° C. to completely volatilize the solvent to obtain the desired measurement target (powder).

### <<Method for Measuring Conductive Carbon Content>>

### [Measurement Method A]

A sample having a weight w1 is taken from a homogeneously mixed product of the measurement target, and the sample is subjected to thermogravimetry differential thermal analysis (TG-DTA) implemented by following step A1 defined below, to obtain a TG curve. From the obtained TG curve, the following first weight loss amount M1 (unit: % by mass) and second weight loss amount M2 (unit: % by mass) are obtained. By subtracting M1 from M2, the conductive carbon content (unit: % by mass) is obtained.

Step A1: A temperature of the sample is raised from 30° C. to 600° C. at a heating rate of 10° C./min and holding the temperature at 600° C. for 10 minutes in an argon gas stream of 300 mL/min to measure a resulting mass w2 of the sample, from which a first weight loss amount M1 is determined by formula (a1):

$$M 1 = ( w 1 - w 2 ) / w 1 \times 100. \qquad ( a1 )$$

Step A2: Immediately after the step A1, the temperature is lowered from 600° C. to 200° C. at a cooling rate of 10° C./min and held at 200° C. for 10 minutes, followed by completely substituting the argon gas stream with an oxygen gas stream. The temperature is raised from 200° C. to 1000° C. at a heating rate of 10° C./min and held at 1000° C. for 10 minutes in an oxygen gas stream of 100 mL/min to measure a resulting mass w3 of the sample, from which a second weight loss amount M2 (unit: % by mass) is calculated by formula (a2):

$$M 2 = ( w 1 - w 3 ) / w 1 \times 100. \qquad ( a2 )$$

### [Measurement Method B]

0.0001 mg of a precisely weighed sample is taken from a homogeneously mixed product of the measurement target, and the sample is burnt under burning conditions defined below to measure an amount of generated carbon dioxide by a CHN elemental analyzer, from which a total carbon content M3 (unit: % by mass) of the sample is determined. Also, a first weight loss amount M1 is determined following the procedure of the step A1 of the measurement method A. By subtracting M1 from M3, the conductive carbon content (unit: % by mass) is obtained.

### [Burning Conditions]

Combustion furnace temperature: 1150° C.
Reduction furnace temperature: 850° C.
Helium flow rate: 200 mL/min.
Oxygen flow rate: 25 to 30 mL/min.

### [Measurement Method C]

The total carbon content M3 (unit: % by mass) of the sample is measured in the same manner as in the above measurement method B. Further, the carbon amount M4 (unit: % by mass) of carbon derived from the binder is determined by the following method. M4 is subtracted from M3 to determine a conductive carbon content (unit: % by mass).

When the binder is polyvinylidene fluoride (PVDF: monomer (CH2_{CF}2). molecular weight 64), the conductive carbon content can be calculated by the following formula from the fluoride ion (F.) content (unit: % by mass) measured by combustion ion chromatography based on the tube combustion method, the atomic weight (19) of fluorine in the monomers constituting PVDF, and the atomic weight (12) of carbon in the PVDF.

$$PVDF content ( unit : \% by mass ) = fluoride ion content ( unit : \% by mass ) \times 64 / 38$$

$$PVDF - derived carbon amount M 4 ( unit : \% by mass ) = fluoride ion \\ \\ content ( unit : \% by mass ) \times 12 / 19$$

The presence of polyvinylidene fluoride as a binder can be verified by a method in which a sample or a liquid obtained by extracting a sample with an N,N-dimethylformamide solvent is subjected to Fourier transform infrared spectroscopy to confirm the absorption attributable to the C—F bond. Such verification can be likewise implemented by nuclear magnetic resonance spectroscopy (19F-NMR).

When the binder is identified as being other than PVDF, the carbon amount M4 attributable to the binder can be calculated by determining the amount (unit: % by mass) of the binder from the measured molecular weight, and the carbon content (unit: % by mass).

These methods are described in the following publications:
Toray Research Center, The TRC News No. 117 (September 2013), pp. 34-37. [Searched on Feb. 10, 2021], Internet <https://www.toray-research.co.jp/technical-info/trcnews/pdf/TRC117 (34-37).pdf>
TOSOH Analysis and Research Center Co., Ltd., Technical Report No. T1019 2017.09.20, [Searched on Feb. 10, 2021], Internet <http://www.tosoh-arc.co.jp/techrepo/files/tarc00522/T1719N.pdf>

### <<Analytical Method for Conductive Carbon>>

The conductive carbon in the active material coating section of the positive electrode active material and the conductive carbon as the conducting agent can be distinguished by the following analytical method.

For example, particles in the positive electrode active material layer are analyzed by a combination of transmission electron microscopy-electron energy loss spectroscopy (TEM-EELS), and particles having a carbon-derived peak around 290 eV only near the particle surface can be judged to be the positive electrode active material. On the other hand, particles having a carbon-derived peak inside the particles can be judged to be the conducting agent. In this context. “near the particle surface” means a region to the depth of 100 nm from the particle surface, while “inside” means an inner region positioned deeper than the “near the particle surface”.

As another method, the particles in the positive electrode active material layer are analyzed by Raman spectroscopy mapping, and particles showing carbon-derived G-band and D-band as well as a peak of the positive electrode active material-derived oxide crystals can be judged to be the positive electrode active material particles that are 5 the coated particles described above. On the other hand, particles showing only G-band and D-band can be judged to be the conducting agent.

As still another method, a cross section of the positive electrode active material layer is observed with scanning spread resistance microscope (SSRM). When the particle surface has a region with lower resistance than the inside of the particle, the region with lower resistance can be judged to be the conductive carbon present in the active material coating section. Other particles that are present isolatedly and have low resistance can be judged to be the conducting agent.

In this context, a trace amount of carbon considered to be an impurity and a trace amount of carbon unintentionally detached from the surface of the positive electrode active material during production are not judged to be the conducting agent.

Using any of these methods, it is possible to verify whether or not the conducting agent formed of carbon material is contained in the positive electrode active material layer.

### Second Embodiment

The positive electrode 1 of the present embodiment has: a positive electrode current collector 11 including a positive electrode current collector main body 14; and a positive electrode active material layer 12 present on the positive electrode current collector 11, wherein the positive electrode active material layer 12 includes a positive electrode active material, and X is 0.5 to 3.5% by mass, as calculated by the following formula (a3).

$$X = M 2 - M 1 \qquad ( a3 )$$

M1 in the formula (a3) is the same as the first weight loss amount M1 (unit: % by mass) obtained by the formula (a1) in the measurement method A.

M2 in the formula (a3) is the same as the second weight loss amount M2 (unit: % by mass) obtained by the formula (a2) in the measurement method A.

The value of X is preferably 0.8 to 3.0% by mass, even more preferably 1.0 to 1.5% by mass. When X is not less than the lower limit value of the above range, the positive electrode shows an excellent impedance reduction effect and a high capacity retention in a high rate charge/discharge cycle under a high temperature environment. When X is not more than the upper limit value, the positive electrode shows an excellent effect of improving volumetric energy density.

### Third Embodiment

The positive electrode 1 of the present embodiment has: a positive electrode current collector 11 including a positive electrode current collector main body 14; and a positive electrode active material layer 12 present on the positive electrode current collector 11, wherein the positive electrode active material layer 12 includes a positive electrode active material, and Y is 0.5 to 3.5% by mass as calculated by the following formula (a4).

$$Y = M 3 - M 1. \qquad ( a4 )$$

M1 in the formula (a4) is the same as the first weight loss amount M1 (unit: % by mass) in the measurement method B.

M3 in the formula (a4) is the same as the total carbon content M3 (unit: % by mass) in the measurement method B.

The value of Y is preferably 0.8 to 3.0% by mass, even more preferably 1.0 to 1.5% by mass. When Y is not less than the lower limit value of the above range, the positive electrode shows an excellent impedance reduction effect and a high capacity retention in a high rate charge/discharge cycle under a high temperature environment. When Y is not more than the upper limit value, the positive electrode shows an excellent effect of improving volumetric energy density.

In the present embodiment, the volume density of the positive electrode active material layer 12 is preferably 2.00 to 2.80 g/cm³, more preferably 2.2 to 2.7 g/cm³, even more preferably 2.3 to 2.6 g/cm³.

The volume density of the positive electrode active material layer 12 can be measured by, for example, the following measuring method.

The thicknesses of the positive electrode 1 and the positive electrode current collector 11 are each measured with a micrometer, and the difference between these two thickness values is calculated as the thickness of the positive electrode active material layer 12. With respect to the thickness of the positive electrode 1 and the thickness of the positive electrode current collector 11, each of these thickness values is an average value of the thickness values measured at five or more arbitrarily chosen points. The thickness of the positive electrode current collector 11 may be measured at the exposed section 13 of the positive electrode current collector, which is described below.

The mass of the measurement sample punched out from the positive electrode so as to have a predetermined area is measured, from which the mass of the positive electrode current collector 11 measured in advance is subtracted to calculate the mass of the positive electrode active material layer 12.

The volume density of the positive electrode active material layer 12 is calculated by the following formula (I).

$$Volume density ( unit : g / {cm}^{3} ) = mass of positive electrode active material layer ( unit : g ) / [ ( thickness of positive electrode active material layer ( unit : cm ) ) \times area of measurement sample ( unit : {cm}^{2} ) ] \qquad ( 1 )$$

When the volume density of the positive electrode active material layer 12 is not less than the lower limit value of the above range, excellent effect of improving the volumetric energy density is achieved. When the volume density is not more than the upper limit value, excellent peel strength of the positive electrode active material layer 12 is achieved. When the volume density of the positive electrode active material layer 12 is too high, the positive electrode active material layer 12 tends to crack easily, and the peel strength tends to decrease. This also results in lower capacity retention in high rate charge/discharge cycle under a high temperature environment. Too low a volume density tends to weaken the contact between conductivity-imparting substances such as the positive electrode active material, the conducting agent, and the positive electrode current collector. As a result, the peel strength tends to decrease and the impedance tends to increase. Further, the capacity retention in high rate charge/discharge cycle under a high-temperature environment decreases as well.

The volume density of the positive electrode active material layer 12 can be controlled by, for example, adjusting the amount of the positive electrode active material, the particle size of the positive electrode active material, the thickness of the positive electrode active material layer 12, and the like. When the positive electrode active material layer 12 contains a conducting agent, the volume density can also be controlled by selecting the type of the conducting agent (specific surface area, specific gravity), or adjusting the amount of the conducting agent, and the particle size of the conducting agent.

In the present embodiment, the peel strength of the positive electrode active material layer 12 is preferably 10 to 1,000 mN/cm, more preferably 20 to 500 mN/cm, and even more preferably 50 to 300 mN/cm.

In the context of the present specification, the peel strength of the positive electrode active material layer 12 is the 180° peel strength obtained by the measuring method described in the Examples section described below.

The peel strength can be controlled by, for example, adjusting the amounts of the binder and the conducting agent. The larger the amount of the binder, the higher the peel strength. By reducing the amount of the conducting agent, which has a large surface area and requires more binder than the active material, the amount of binder required to obtain satisfactory peel strength can be reduced.

When the peel strength of the positive electrode active material layer 12 is not less than the lower limit value of the above range, excellent adhesion is achieved between the positive electrode current collector 11 and the positive electrode active material layer 12. When the peel strength is not more than the upper limit value, excellent effect of improving the volumetric energy density is achieved.

### [Method for Producing Positive Electrode]

The present embodiment's method for producing the positive electrode 1 includes a composition preparation step of preparing a positive electrode composition containing a positive electrode active material, and a coating step of coating the positive electrode composition on the positive electrode current collector 11.

For example, the positive electrode 1 can be produced by applying the positive electrode composition containing a positive electrode active material and a solvent onto the positive electrode current collector 11, followed by drying to remove the solvent to form the positive electrode active material layer 12. The positive electrode composition may contain a conducting agent. The positive electrode composition may contain a binder.

The thickness of the positive electrode active material layer 12 can be adjusted by a method in which a layered body composed of the positive electrode current collector 11 and the positive electrode active material layer 12 formed thereon is placed between two flat plate jigs and, then, uniformly pressurized in the thickness direction of this layered body. For this purpose, for example, a method of pressurizing using a roll press can be used.

The solvent for the positive electrode composition is preferably a non-aqueous solvent. Examples of the solvent include alcohols such as methanol, ethanol. 1-propanol and 2-propanol; chain or cyclic amides such as N-methylpyrrolidone and N,N-dimethylformamide; and ketones such as acetone. With respect to these solvents, a single type thereof may be used individually or two or more types thereof may be used in combination.

In the first embodiment, the positive electrode 1 with a positive electrode active material layer not containing a conducting agent can be produced by a method in which the composition preparation step described above is a step of preparing the positive electrode composition without mixing the positive electrode active material with any of a conducting agent and a compound capable of turning into a conducting agent after the coating step.

That is, such a positive electrode 1 can be produced by a method in which the positive electrode composition is prepared in the composition preparation step without implementing any of: mixing of the positive electrode active material with a conducting agent; mixing of the positive electrode active material with a compound capable of turning into a conducting agent after the coating step; and mixing of the positive electrode active material with a conducting agent and a compound capable of turning into a conducting agent after the coating step.

Examples of the compound capable of turning into a conducting agent after the coating step include carbon-containing compounds that produce carbon by heat treatment. When the positive electrode active material and the carbon-containing compound are mixed and used, the heat treatment is not performed after the mixing, or the heat treatment is performed in a manner such that the carbon generated by the heat treatment does not remain as independent carbon particles after the coating process.

The positive electrode 1 of the second embodiment is preferably produced by a method in which the composition preparation step described above is a step of preparing the positive electrode composition without mixing the positive electrode active material with any of a conducting agent and a compound capable of turning into a conducting agent after the coating step.

The positive electrode 1 of the third embodiment is preferably produced by a method in which the composition preparation step described above is a step of preparing the positive electrode composition without mixing the positive electrode active material with any of a conducting agent and a compound capable of turning into a conducting agent after the coating step.

### <Non-Aqueous Electrolyte Secondary Battery>

The non-aqueous electrolyte secondary battery 10 of the present embodiment shown in FIG. 2 includes a positive electrode 1 of the present embodiment, a negative electrode 3, and a non-aqueous electrolyte. Further, a separator 2 may be provided. Reference numeral 5 in FIG. 1 denotes an outer casing.

In the present embodiment, the positive electrode 1 has a plate-shaped positive electrode current collector 11 and positive electrode active material layers 12 provided on both surfaces thereof. The positive electrode active material layer 12 is present on a part of each surface of the positive electrode current collector 11. The edge of the surface of the positive electrode current collector 11 is an exposed section 13 of the positive electrode current collector, which is free of the positive electrode active material layer 12. A terminal tab (not shown) is electrically connected to an arbitrary portion of the exposed section 13 of the positive electrode current collector.

The negative electrode 3 has a plate-shaped negative electrode current collector 31 and negative electrode active material layers 32 provided on both surfaces thereof. The negative electrode active material layer 32 is present on a part of each surface of the negative electrode current collector 31. The edge of the surface of the negative electrode current collector 31 is an exposed section 33 of the negative electrode current collector, which is free of the negative electrode active material layer 32. A terminal tab (not shown) is electrically connected to an arbitrary portion of the exposed section 33 of the negative electrode current collector.

The shapes of the positive electrode 1, the negative electrode 3 and the separator 2 are not particularly limited. For example, each of these may have a rectangular shape in a plan view.

With regard to the production of the non-aqueous electrolyte secondary battery 10 of the present embodiment, for example, the production can be implemented by a method in which the positive electrode 1 and the negative electrode 3 are alternately interleaved through the separator 2 to produce an electrode layered body, which is then packed into an outer casing 5 such as an aluminum laminate bag, and a non-aqueous electrolyte (not shown) is injected into the outer casing, followed by sealing the outer casing 5. FIG. 2 shows a representative example of a structure of the battery in which the negative electrode, the separator, the positive electrode, the separator, and the negative electrode are stacked in this order, but the number of electrodes can be altered as appropriate. The number of the positive electrode 1 may be one or more, and any number of positive electrodes 1 can be used depending on a desired battery capacity. The number of each of the negative electrode 3 and the separator 2 is larger by one sheet than the number of the positive electrode 1, and these are stacked so that the negative electrode 3 is located at the outermost layer.

### [Negative Electrode]

The negative electrode active material layer 32 includes a negative electrode active material. Further, the negative electrode active material layer 32 may further include a binder. Furthermore, the negative electrode active material layer 32 may include a conducting agent as well. The shape of the negative electrode active material is preferably particulate.

For example, the negative electrode 3 can be produced by a method in which a negative electrode composition containing a negative electrode active material, a binder and a solvent is prepared, and coated on the negative electrode current collector 31, followed by drying to remove the solvent to thereby form a negative electrode active material layer 32. The negative electrode composition may contain a conducting agent.

Examples of the negative electrode active material and the conducting agent include carbon materials such as graphite, graphene, hard carbon, Ketjen black, acetylene black, and carbon nanotube. With respect to each of the negative electrode active material and the conducting agent, a single type thereof may be used alone or two or more types thereof may be used in combination.

Examples of the material of the negative electrode current collector 31, the binder and the solvent in the negative electrode composition include those listed above as examples of the material of the positive electrode current collector 11, the binder and the solvent in the positive electrode composition. With respect to each of the binder and the solvent in the negative electrode composition, a single type thereof may be used alone or two or more types thereof may be used in combination.

The sum of the amount of the negative electrode active material and the amount of the conducting agent relative to the total mass of the negative electrode active material layer 32 is preferably 80.0 to 99.9% by mass, more preferably 85.0 to 98.0% by mass.

### [Separator]

The separator 2 is disposed between the negative electrode 3 and the positive electrode 1 to prevent a short circuit or the like. The separator 2 may retain a non-aqueous electrolyte described below.

The separator 2 is not particularly limited, and examples thereof include a porous polymer film, a non-woven fabric, and glass fiber.

An insulating layer may be provided on one or both surfaces of the separator 2. The insulating layer is preferably a layer having a porous structure in which insulating fine particles are bonded with a binder for an insulating layer.

The separator 2 may contain various plasticizers, antioxidants, and flame retardants.

Examples of the antioxidant include phenolic antioxidants such as hinderedphenolic antioxidants, monophenolic antioxidants, bisphenolic antioxidants, and polyphenolic antioxidants; hinderedamine antioxidants; phosphorus antioxidants; sulfur antioxidants; benzotriazole antioxidants; benzophenone antioxidants; triazine antioxidants; and salicylate antioxidants. Among these, phenolic antioxidants and phosphorus antioxidants are preferable.

### [Non-Aqueous Electrolyte Solution]

The non-aqueous electrolyte solution fills the space between the positive electrode 1 and the negative electrode 3. For example, any of known non-aqueous electrolyte solutions used in lithium ion secondary batteries, electric double layer capacitors and the like can be used.

The non-aqueous electrolyte used in the manufacture of the nonaqueous electrolyte secondary battery 10 contains an organic solvent, an electrolyte, and an additive.

After manufacture, especially after initial charging, the nonaqueous electrolyte secondary battery 10 contains an organic solvent and an electrolyte, and may further contain residues or traces derived from the additives.

The organic solvent is preferably one having tolerance to high voltage. Examples of the organic solvent include polar solvents such as ethylene carbonate, propylene carbonate, dimethyl carbonate, diethyl carbonate, ethyl methyl carbonate, γ-butyrolactone, sulfolane, dimethyl sulfoxide, acetonitrile, dimethylformamide, dimethylacetamide. 1,2-dimethoxyethane, 1,2-diethoxyethane, tetrohydrafuran, 2-methyltetrahydrofuran, dioxolane, and methyl acetate, as well as mixtures of two or more of these polar solvents.

The electrolyte salt is not particularly limited, and examples thereof include lithium-containing salts such as lithium perchlorate (LiClO₄), lithium hexafluorophosphate (LiPF₆), lithium tetrafluoroborate (LiBF₄), lithium hexafluoroarsenate (LiAsF₆), lithium trifluoroacetate (LiCF₃CO₂), lithium bis(fluorosulfonyl)imide (LiFSI), and lithium bis(trifluoromethanesulfonyl)imide (LiTFSI), or a mixture of two or more of these salts.

The non-aqueous electrolyte secondary battery of the present embodiment can be used as a lithium ion secondary battery for various purposes such as industrial use, consumer use, automobile use, and residential use.

The application of the non-aqueous electrolyte secondary battery of this embodiment is not particularly limited. For example, the battery can be used in a battery module configured by connecting a plurality of non-aqueous electrolyte secondary batteries in series or in parallel, a battery system including a plurality of electrically connected battery modules and a battery control system, and the like.

Examples of the battery system include battery packs, stationary storage battery systems, automobile power storage battery systems, automobile auxiliary storage battery systems, emergency power storage battery systems, and the like.

According to the present embodiment, a non-aqueous electrolyte secondary battery having an excellent volumetric energy density can be obtained. For example, it is possible to achieve a volumetric energy density of 260 Wh/L or more, preferably 285 Wh/L or more, more preferably 290 Wh/L or more.

Further, although the impedance (resistance) and the volumetric energy density tend to be in a trade-off relationship where one of these properties decreases when the other one is improved, the present embodiment enables the battery to achieve the reduction of impedance and the improvement of the volumetric energy density at the same time.

Further, according to the present embodiment, it is possible to secure durability of the battery even under the severe conditions for a rapid (high rate) charge/discharge cycle in a high temperature environment, and to achieve a good capacity retention of the battery.

### EXAMPLES

Hereinbelow, the present invention will be described with reference to Examples which, however, should not be construed as limiting the present invention.

### <Measuring Method>

### [Volume Density Measuring Method]

The thickness of the positive electrode sheet and the thickness of the positive electrode current collector at its exposed section 13 were measured using a micrometer. Each thickness was measured at 5 arbitrarily chosen points, and an average value was calculated.

5 sheets of measurement samples were prepared by punching the positive electrode sheet into circles with a diameter of 16 mm.

Each measurement sample was weighed with a precision balance, and the mass of the positive electrode active material layer 12 in the measurement sample was calculated by subtracting the mass of the positive electrode current collector 11 measured in advance from the measurement result. The volume density of the positive electrode active material layer was calculated from the average value of measurements by the above formula (I).

### <Evaluation Method>

### [Method for Measuring the Proportion of Conductive Carbon Species]

Whether the carbon in the active material coating section is crystalline or amorphous was determined by checking the sp² bond ratio from the difference in the shape of the EELS spectrum (C-K edge). The EELS spectrum was measured at 20 points on the surface of the positive electrode active material to determine whether the proportion of crystalline or amorphous was greater. The results are shown in Table 2.

The TEM-EELS spectrum measurement for positive electrode active material particles can be performed according to the following steps (1) to (5).
(1) The positive electrode active material layer is exclusively peeled off from the positive electrode with a spatula. In this process, care must be taken so as not to remove the current collector foil as well.
(2) The positive electrode active material layer obtained in (1) above is observed using a transmission electron microscope, such as HD2700 manufactured by Hitachi High-Tech Corporation.
(3) The transmission electron microscope-energy dispersive X-ray spectroscopy is implemented in advance to identify, as the positive electrode active material particle, one particle for which a peak of a metal derived from the positive electrode active material, such as Fe, is detected.
(4) EELS spectra are obtained for multiple observation points, for example 30 points, arbitrarily selected from the surface layer portion of the positive electrode active material particle identified in (3) and having a thickness of 100 nm or less. The measurement conditions for the EELS spectra are, for example, an acceleration voltage of high-speed electrons of 200 kV when using the Hitachi High-Tech's HD2700. In order to optimize the EELS spectrum, the voltage and other conditions can be adjusted as appropriate depending on the target object and measuring device.
(5) For the EELS spectrum at each observation point, it is determined whether there is one or more peaks in the range of 280 to 290 eV that are significantly different from the baseline. When there is one or more such peaks at all observation points, it is determined that there is a peak in the range of 280 to 290 eV. In this context, a peak being “significant different” means a peak having an intensity of 0.001% or more when the “maximum value-minimum value” at the baseline is set to 100%.
(6) For the EELS spectrum at each observation point, the ratio of the peak intensity P285 at 285 eV to the peak intensity P280 at 280 eV is calculated, and the average value for all the observation points is taken as the measured value of the peak intensity ratio (P285/P280).

### [Spreading Resistance of Positive Electrode Active Material Surface]

The resistance of the active material coating section was determined by measuring the spreading resistance. The surface of the positive electrode active material was measured at 20 points, and the average value was calculated. The results are shown in Table 2.

### [Measurement Method for Peel Strength]

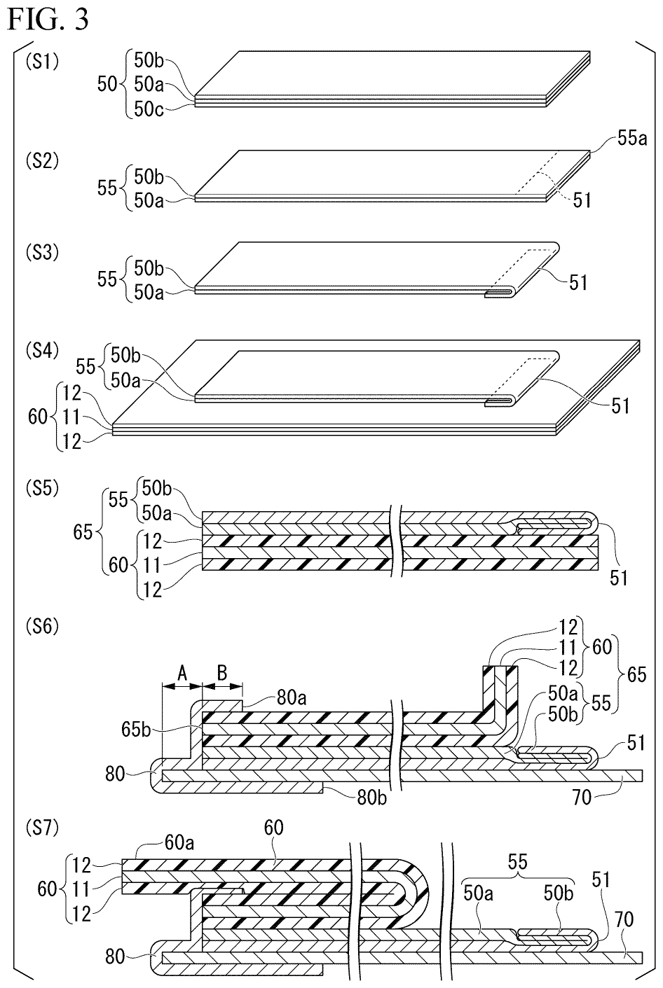

The peel strength of the positive electrode active material layer 12 can be measured by the following method using a tensile tester. FIG. 3 is a process diagram showing a method for measuring the peel strength of the positive electrode active material layer. The steps (S1) to (S7) shown in FIG. 3 are respectively described below. FIG. 3 is a schematic diagram for facilitating the understanding of the configuration, and the dimensional ratios and the like of each component do not necessarily represent the actual ones.
(S1) First, a rectangular double-sided tape 50 having a width of 25 mm and a length of 120 mm is prepared. In the double-sided tape 50, release papers 50b and 50c are laminated on both sides of the adhesive layer 50a. As the double-sided tape 50, a product manufactured and sold by Nitto Denko Corporation with a product name “No. 5015, 25 mm width” is used.
(S2) The release paper 50c on one side of the double-sided tape 50 is peeled off to obtain an adhesive body 55 with the surface of the adhesive layer 50a (hereinafter, also referred to as “glue surface”) being exposed. In the adhesive body 55, a bending position 51 is provided at a distance of about 10 mm from one end 55a in the longitudinal direction of the adhesive body 55.
(S3) The adhesive body 55 is bent at a position on the one end 55a side as viewed from the bending position 51 such that the glue surfaces adhere to each other.
(S4) The adhesive body 55 and the positive electrode sheet 60 are bonded together such that the glue surface of the adhesive body 55 and the positive electrode active material layer 12 of the positive electrode sheet 60 are in contact with each other.
(S5) The positive electrode sheet 60 is cut out along the outer edge of the adhesive body 55, and the adhesive body 55 and the positive electrode sheet 60 are crimped to obtain a composite 65 by a method of reciprocating a crimping roller twice in the longitudinal direction.
(S6) The outer surface of the composite 65 on the adhesive body 55 side is brought into contact with one surface of a stainless plate 70, and the other end 65b on the side opposite to the bending position 51 is fixed to the stainless plate 70 with a mending tape 80. As the mending tape 80, a product manufactured and sold by 3M Company with a product name “Scotch Tape Mending Tape 18 mm×30 Small Rolls 810-1-18D” is used. The length of the mending tape 80 is about 30 mm, the distance A from an end of the stainless plate 70 to the other end 65b of the composite 65 is about 5 mm, and the distance B from one end 80a of the mending tape 80 to the other end 65b of the composite 65 is 5 mm. The other end 80b of the mending tape 80 is attached to the other surface of the stainless plate 70.
(S7) At the end of the composite 65 on the bending position 51 side, the positive electrode sheet 60 is slowly peeled off from the adhesive 55 in parallel with the longitudinal direction. The end (hereinafter, referred to as “peeling end”) 60a of the positive electrode sheet 60 that is not fixed by the mending tape 80 is slowly peeled off until it protrudes from the stainless steel plate 70.

Next, the stainless plate 70 to which the composite 65 is fixed is installed on a tensile tester (product name “EZ-LX”, manufactured by Shimadzu Corporation) (not shown), the end of the adhesive 55 on the bending position 51 side is fixed, and the peeling end 60a of the positive electrode sheet 60 is pulled in the direction opposite to the bending position 51 (180° direction with respect to the bending position 51) at a test speed of 60 mm/min, a test force of 50,000 mN, and a stroke of 70 mm to measure the peel strength. The average value of the peel strength at a stroke of 20 to 50 mm is taken as the peel strength of the positive electrode active material layer 12.

### [Measurement Method for Volumetric Energy Density]

The evaluation of the volumetric energy density was performed according to the following procedures (1) to (3).
(1) A cell was prepared so as to have a rated capacity of 1 Ah, and the volume of the cell was measured. The volume was measured by Archimedes' principle. The volume measurement may be performed by other methods. To name a few, a method using a laser volume meter or a 3D scan can be employed.
(2) In an environment of 25° C., the obtained cell was charged at a constant current rate of 0.2 C (that is, 200 mA) and with a cut-off voltage of 3.6 V, and then charged at a constant voltage with a cut-off current set at 1/10 of the above-mentioned charge current (that is, 20 mA). Then, a 30-minute pause was provided while leaving the cell in the open circuit state.
(3) The cell was discharged at a constant current rate of 0.2 C and with a cut-off voltage of 2.5 V. In this process, the weight energy density (unit: Wh/L) was calculated by dividing the total discharge power (unit: Wh) measured from the start of discharge to the end of discharge by the cell volume (unit: L) measured in (1).

### [Measurement Method for Impedance (Alternating Current Resistance)]

A cell was prepared so as to have a rated capacity of 1 Ah, and the obtained cell was charged at a constant current rate of 0.2 C (that is, 200 mA) and with a cut-off voltage of 3.6V at room temperature (25° C.). Then, the cell was charged at a constant voltage with a cut-off current set at 1/10 of the above-mentioned charge current (that is, mA), followed by measurement of impedance under the conditions of room temperature (25° C.) and frequency of 1 kHz.

The measurement was carried out by 4-terminal method in which a current terminal and a voltage terminal are attached to the positive and negative electrode tabs, respectively. As an example, an impedance analyzer manufactured by BioLogic was used for the measurement.

### [High Temperature-High Rate Cycle Test]

The capacity retention was evaluated following the procedures (1) to (7) below.
(1) A non-aqueous electrolyte secondary battery (cell) was manufactured so as to have a rated capacity of 1 Ah.
(2) In an environment of 25° C., the obtained cell was charged at a constant current rate of 0.2 C (that is, 200 mA) and with a cut-off voltage of 3.6 V, and then charged at a constant voltage with a cut-off current set at 1/10 of the above-mentioned charge current (that is, 20 mA).
(3) The cell was discharged for capacity confirmation in an environment of 25° C. at a constant current rate of 0.2 C and with a cut-off voltage of 2.5 V. The discharge capacity at this time was set as the reference capacity, and the reference capacity was set as the current value at 1 C rate (that is, 1,000 mA).
(4) After charging the cell at a constant current at a cell's 3 C rate (that is, 3000 mA) and with a cut-off voltage of 3.8 V in an environment of 60° C., a 10-second pause was provided. From this state, the cell was discharged at 3 C rate and with a cut-off voltage of 2.0 V, and a 10-second pause was provided.
(5) The cycle test of (4) was repeated 1,000 times in an environment of 60° C.
(6) After performing the same charging as in (2) in an environment of 25° C., the same capacity confirmation as in (3) was performed.
(7) By dividing the discharge capacity in the capacity confirmation measured in (6) by the reference capacity before the cycle test in an environment of 60° C. to obtain a capacity retention after 1,000 cycles in terms of percentage (1,000 cycle capacity retention, unit: %).

### Production Example 1: Production of Negative Electrode

100 parts by mass of artificial graphite as a negative electrode active material, 1.5 parts by mass of styrene-butadiene rubber as a binder, 1.5 parts by mass of carboxymethyl cellulose Na as a thickener, and water as a solvent were mixed, to thereby obtain a negative electrode composition having a solid content of 50% by mass.

The obtained negative electrode composition was applied onto both sides of a copper foil (thickness 8 μm) and vacuum dried at 100° C. Then, the resulting was pressure-pressed under a load of 2 kN to obtain a negative electrode sheet. The obtained negative electrode sheet was punched to obtain a negative electrode.

### Examples 1 to 9

Examples 1 to 6 are implementation of the present invention, while Examples 7 to 9 are comparative examples.

A carbon-coated lithium iron phosphate (hereinbelow, also referred to as “carbon-coated active material”) with an average particle size of 1.0 μm and a carbon content of 1% by mass was used as a positive electrode active material. The thickness of the coated section of the active material was in the range of 1 to 100 nm.

Carbon black was used as a conducting agent.

Polyvinylidene fluoride (PVDF) was used as a binder.

### Example 1

First, a positive electrode current collector 11 was prepared by coating both the front and back surfaces of a positive electrode current collector main body 14 with current collector coating layers 15 by the following method. An aluminum foil (thickness 15 μm) was used as the positive electrode current collector main body 14.

A slurry was obtained by mixing 100 parts by mass of carbon black. 40 parts by mass of polyvinylidene fluoride as a binder, and N-methylpyrrolidone (NMP) as a solvent. The amount of NMP used was the amount required for applying the slurry.

The obtained slurry was applied to both sides of the positive electrode current collector main body 14 by a gravure method so as to allow the resulting current collector coating layers 15 after drying (total of layers on both sides) to have a thickness of 2 μm, and dried to remove the solvent, thereby obtaining a positive electrode current collector 11. The current collector coating layers 15 on both surfaces were formed so as to have the same amount of coating and the same thickness.

Next, a positive electrode active material layer 12 was formed by the following method.

With the blending ratio shown in Table 1, the positive electrode active material, the conducting agent, the binder, and the solvent (NMP) were mixed with a mixer to obtain a positive electrode composition. The amount of the solvent used was the amount required for applying the positive electrode composition.

The positive electrode composition was applied on both sides of the positive electrode current collector 11, and after pre-drying, the applied composition was vacuum-dried at 120° C. to form positive electrode active material layers 12. The amount of the applied positive electrode composition is shown in Table 2. The resulting laminate was pressure-pressed with a load of 10 kN to obtain a positive electrode sheet.

Using the obtained positive electrode sheet as a sample, the conductive carbon content, volume density, and peel strength were measured. The results are shown in Table 2.

The thickness values of the positive electrode active material layer and the current collector coating layer, the carbon content and compounding amount of the carbon-coated active material, the carbon content and compounding amount of the conducting agent, and the amount carbon black (its carbon content was assumed to be 100% by mass) in the current collector coating layer were used to calculate the amount of conductive carbon with respect to the sum of the mass of the positive electrode active material layer and the mass of the current collector coating layer (that is, the amount of conductive carbon with respect to a mass of the positive electrode excluding the positive electrode current collector main body). The conducting agent was regarded as having an impurity content of less than the quantification limit and a carbon content of 100% by mass. The amount of conductive carbon with respect to the mass of the positive electrode excluding the positive electrode current collector main body can also be confirmed by using the method described in the <<Method for measuring conductive carbon content>> described above.

The amount of the binder based on the total mass of the positive electrode active material layer was calculated from the blending amount of the binder. The conducting agent was regarded as having an impurity content of less than the quantification limit and a carbon content of 100% by mass. The amount of the binder based on the total mass of the positive electrode active material layer can also be confirmed by using the method described in the <<Method for measuring conductive carbon content>> described above.

The results are shown in Table 2. In Table 2, the coating amount of the positive electrode composition and the thickness of the positive electrode active material layer are total values with respect to the positive electrode active material layers 12 on both sides of the positive electrode current collector 11. The positive electrode active material layers 12 on both surfaces of the positive electrode current collector 11 were formed so as to have the same coating amount and the same thickness.

The obtained positive electrode sheet was punched to obtain a positive electrode.

A non-aqueous electrolyte secondary battery having a configuration shown in FIG. 2 was manufactured by the following method.

LiPF₆ as an electrolyte was dissolved at 1 mol/L in a solvent in which ethylene carbonate (EC) and diethyl carbonate (DEC) were mixed at a volume ratio, EC:DEC, of 3:7, to thereby prepare a non-aqueous electrolytic solution.

The positive electrode obtained in this example and the negative electrode obtained in Production Example 1 were alternately interleaved through a separator to prepare an electrode layered body with its outermost layer being the negative electrode. A polyolefin film (thickness 15 μm) was used as the separator.

In the step of producing the electrode layered body, the separator 2 and the positive electrode 1 were first stacked, and then the negative electrode 3 was stacked on the separator 2.

Terminal tabs were electrically connected to the exposed section 13 of the positive electrode current collector and the exposed section 33 of the negative electrode current collector in the electrode layered body, and the electrode layered body was put between aluminum laminate films while allowing the terminal tabs to protrude to the outside. Then, the resulting was laminate-processed and sealed at three sides.

To the resulting structure, a non-aqueous electrolytic solution was injected from one side left unsealed, and this one side was vacuum-sealed to manufacture a non-aqueous electrolyte secondary battery (laminate cell).

The volumetric energy density and impedance were measured by the above methods. The high temperature-high rate cycle test was carried out by the above method to measure the 1,000 cycle capacity retention. The results are shown in Table 2.

### Example 2

The load for the pressure-press was changed from that in Example 1 so as to give a volume density shown in Table 2. Except for these points, the same procedures as in Example 1 were repeated to prepare a positive electrode, and manufacture and evaluate a secondary battery.

### Examples 3 to 7

The blending ratio for the positive electrode composition was changed from that in Example 1 to that shown in Table 1. Further, the coating amount and the load for the pressure press were adjusted so as to give the volume density shown in Table 2.

Except for these points, the same procedures as in Example 1 were repeated to prepare a positive electrode, and manufacture and evaluate a secondary battery.

### Example 8

In this example, an aluminum foil (thickness 15 μm) having no current collector coating layer was used as the positive electrode current collector.

The positive electrode composition with the blending ratio shown in Table 1 was applied to both surfaces of the aluminum foil, and after pre-drying, and the applied composition was vacuum-dried at 120° C. to form positive electrode active material layers 12. The obtained laminate was pressure-pressed to obtain a positive electrode sheet. The coating amount and the load for the pressure press were adjusted so as to give the volume density shown in Table 2. The obtained positive electrode sheet was punched to obtain a positive electrode.

Using the positive electrode obtained in this example, a secondary battery was manufactured and evaluated in the same manner as in Example 1.

### Example 9

In this Example, the positive electrode active material used was one whose surface was coated with crystalline graphene. For the method of coating the positive electrode active material with graphene, the coating was implemented using graphene oxide, referring to paragraphs 0031 to 0033 of Patent Document 2, while adjusting the thickness of the active material coating section to 2.0 nm.

Except for these points, the same procedures as in Example 1 were repeated to prepare a positive electrode, and manufacture and evaluate a secondary battery.

TABLE 1

Blending ratio for positive electrode
composition [Parts by mass]

| | Positive | | | |
|---|---|---|---|---|
| | electrode | | | |
| | active | Conducting | | |
| | material | agent | Binder | Solvent |
| Ex. 1 | 99.0 | 0.5 | 0.5 | Necessary |
| Ex. 2 | 99.0 | 0.5 | 0.5 | amount |
| Ex. 3 | 98.5 | 0.5 | 1.0 | |
| Ex. 4 | 99.5 | 0 | 0.5 | |
| Ex. 5 | 98.5 | 1.0 | 0.5 | |
| Ex. 6 | 98.5 | 1.0 | 0.5 | |
| Ex. 7 | 92.0 | 7.0 | 1.0 | |
| Ex. 8 | 92.5 | 5.5 | 2.0 | |
| Ex. 9 | 99.0 | 0.5 | 0.5 | |

TABLE 2

| | | | | | Thickness | | | | | | | |
|---|---|---|---|---|---|---|---|---|---|---|---|---|
| | | Spreading | | Coating | of positive | | | | | | | |
| | | resistance | | amount of | electrode | | | | | | | |
| | Conductive | of positive | | positive | active | | | | | | | 1,000 cycle |
| | carbon | electrode | | electrode | material | | | | | | | capacity |
| | species | active | Conductive | composition | layer | | | Current | | Volumetric | | retention |
| | present in | material | carbon | (total for | (total for | Volume | Binder | collector | Peel | energy | Impedance | (60° C., |
| | higher | surface | content | both sides) | both sides) | density | content | coating | strength | density | (1 kHz) | 3 C rate ) |
| Unit | proportion | logΩ | wt % | mg/cm² | μm | g/cm³ | wt % | layer | mN/cm | Wh/L | mΩ | % |
| Ex.1 | Amorphous | 7 | 1.5 | 33.0 | 132 | 2.50 | 0.5 | Present | 45.7 | 283 | 7 | 75 |
| Ex.2 | Amorphous | 7 | 1.5 | 33.0 | 143 | 2.30 | 0.5 | Present | 64.4 | 274 | 8 | 72 |
| Ex.3 | Amorphous | 6 | 2.5 | 33.0 | 147 | 2.25 | 1.0 | Present | 107.8 | 263 | 7 | 70 |
| Ex.4 | Amorphous | 7 | 1.0 | 32.8 | 131 | 2.55 | 0.5 | Present | 41.4 | 289 | 6 | 81 |
| Ex.5 | Amorphous | 6 | 1.5 | 33.0 | 120 | 2.75 | 0.5 | Present | 16.9 | 293 | 6 | 42 |
| Ex.6 | Amorphous | 6 | 1.5 | 33.0 | 165 | 2.00 | 0.5 | Present | 20.1 | 258 | 13 | 33 |
| Ex.7 | Amorphous | 5 | 8.0 | 35.5 | 169 | 2.10 | 1.0 | Present | 12.5 | 242 | 7 | 8 |
| Ex.8 | Amorphous | 5 | 6.5 | 35.3 | 172 | 2.05 | 2.0 | Not | 63.2 | 239 | 22 | 5 |
| | | | | | | | | present | | | | |
| Ex.9 | Crystalline | 3 | 1.5 | 33.0 | 132 | 2.50 | 0.5 | Present | 45.3 | 283 | 5 | 7 |

As can be seen from the results shown in Table 2, Examples 1 to 6 with a conductive carbon content of 0.5 to 3.0% by mass showed a high volumetric energy density. In addition, the peel strength of the positive electrode active material layer was good, and the impedance of the non-aqueous electrolyte secondary battery was low. Among Examples 1 to 6, Examples 1 to 4, in which the volume density of the positive electrode active material layer was 2.2 to 2.7 g/cm³, showed higher peel strength and high capacity retention even after 1,000 high-rate charge/discharge cycles at 3 C in a 60° C. environment. Example 4 in particular showed a high capacity retention, which is assumed to have included fewer independent carbon particles with high side reactivity that could cause capacity reduction.

Examples 7 and 8 with high conductive carbon content showed a low volumetric energy density.

In Example 7, the amount of the binder was at the same level as in Example 3. but the positive electrode active material layer was brittle and the peel strength was inferior as compared to Example 3 due to the large amount of the conducting agent.

In Example 8 with the positive electrode current collector having no current collector coating layer, the impedance was liable to increase.

Example 9 with a small amount of amorphous and a large amount of crystalline carbon in the positive electrode active material tended to show a low initial impedance, but the capacity retention in Example 9 decreased after 3 C high-rate charge/discharge cycles in a 60° C. environment. It is presumed that the high reactivity of the positive electrode active material surface increased side reactions with the electrolyte solution during cycling, leading to a decrease in capacity.

### EXPLANATION OF REFERENCE NUMERALS

1 Positive electrode
2 Separator
3 Negative electrode
5 Outer casing
10 Secondary battery
11 Positive electrode current collector
12 Positive electrode active material layer
13 Exposed section of positive electrode current collector
14 Positive electrode current collector main body
15 Current collector coating layer
31 Negative electrode current collector
32 Negative electrode active material layer
33 Exposed section of negative electrode current collector
50 Double-sided tape
50a Adhesive layer
50b Release paper
51 Bending position
55 Adhesive body
60 Positive electrode sheet
70 Stainless steel plate
80 Mending tape

1. A positive electrode for a non-aqueous electrolyte secondary battery, comprising:
a positive electrode current collector having a positive electrode current collector main body formed of a metal material; and
a positive electrode active material layer provided on the positive electrode current collector,
wherein:
the positive electrode active material layer comprises a positive electrode active material and a conducting agent;
one or both of the positive electrode current collector and the positive electrode active material layer comprise conductive carbon;
the conductive carbon comprises amorphous carbon; and
a conductive carbon content based on a mass of the positive electrode excluding the positive electrode current collector main body is 0.5 to 3.5% by mass.

2. The positive electrode according to claim 1, wherein the positive electrode active material has, on at least a part of its surface, a coated section comprising a conductive material.

3. A positive electrode for a non-aqueous electrolyte secondary battery, comprising:
a positive electrode current collector having a positive electrode current collector main body formed of a metal material; and
a positive electrode active material layer provided on the positive electrode current collector,
wherein:
the positive electrode active material layer comprises a positive electrode active material and does not contain a conducting agent;
the positive electrode active material has, on at least a part of its surface, an active material coating section comprising a conductive material;
one or both of the positive electrode current collector and the positive electrode active material layer comprise conductive carbon;
the conductive carbon comprises amorphous carbon; and
a conductive carbon content based on a mass of the positive electrode excluding the positive electrode current collector main body is 0.5 to 3.5% by mass.

4. The positive electrode according to claim 2, wherein the amorphous carbon is present in the active material coating section at a higher proportion than crystalline carbon.

5. The positive electrode according to claim 4, which has a resistance value of 10⁵ to 10⁹Ω as measured with respect to a surface of the positive electrode active material by a scanning spread resistance microscope.

6. The positive electrode according to claim 2, wherein the active material coating section comprises conductive carbon and has at least a region having a thickness of more than 3.4 to 100 nm.

7. The positive electrode according to claim 2, wherein the active material coating section comprises conductive carbon and has at least a region having a thickness of 5 to 80 nm.

8. The positive electrode according to claim 2, wherein the active material coating section comprises conductive carbon and has at least a region having a thickness of 10 to 50 nm.

9. A positive electrode for a non-aqueous electrolyte secondary battery, comprising:
a positive electrode current collector having a positive electrode current collector main body formed of a metal material; and
a positive electrode active material layer provided on the positive electrode current collector,
wherein the positive electrode active material layer comprises a positive electrode active material; and
X is 0.5 to 3.5% by mass as determined by a measurement method A defined below with respect to a dried product, as a measurement target, obtained by removing whole of a layer present on the positive electrode current collector main body, collecting whole of substance resulting from the removed layer, and vacuum-drying the collected substance at 120° C.,
wherein the measurement method A includes:
(1) taking a sample having a weight of w1 from a homogeneously mixed product of the measurement target, and subjecting the sample to thermogravimetry differential thermal analysis implemented by following A1 and A2 defined below, to determine a first weight loss amount M1 (unit: % by mass) and a second weight loss amount M2 (unit: % by mass, wherein:
A1 is raising a temperature of the sample from 30° C. to 600° C. at a heating rate of 10° C./min and holding the temperature at 600° C. for 10 minutes in an argon gas stream of 300 mL/min to measure a resulting mass w2 of the sample, from which a first weight loss amount M1 is determined by formula (a1):
$$M 1 = ( w 1 - w 2 ) / w 1 \times 100 ; \qquad ( a1 )$$
A2 is immediately after the step A1, lowering the temperature from 600° C. to 200° C. at a cooling rate of 10° C./min, holding the temperature at 200° C. for 10 minutes, followed by completely substituting the argon gas stream with an oxygen gas stream, raising the temperature from 200° C. to 1000° C. at a heating rate of 10° C./min in an oxygen gas stream of 100 mL/min, and holding the temperature at 1000° C. for 10 minutes in the same oxygen gas stream to measure a resulting mass w3 of the sample, from which a second weight loss amount M2 is calculated by formula (a2):
$$M 2 = ( w 1 - w 3 ) / w 1 \times 100 ; \qquad ( a2 )$$
and
(2) calculating X by formula (a3):
$$X = M 2 - M 1. \qquad ( a3 )$$

10. A positive electrode for a non-aqueous electrolyte secondary battery, comprising:
a positive electrode current collector having a positive electrode current collector main body formed of a metal material; and
a positive electrode active material layer provided on the positive electrode current collector,
wherein the positive electrode active material layer comprises a positive electrode active material; and
Y is 0.5 to 3.5% by mass as determined by a measurement method B defined below with respect to a dried product, as a measurement target, obtained by removing whole of a layer present on the positive electrode current collector main body, collecting the whole of substance resulting from the removed layer, and vacuum-drying the collected substance at 120° C.,
wherein the measurement method B includes:
(1) taking a sample having a weight of w1 from a homogeneously mixed product of the measurement target, and subjecting the sample to thermogravimetry differential thermal analysis implemented by A1 defined below, to determine a first weight loss amount M1 (unit: % by mass), wherein:
A1 is raising a temperature of the sample from 30° C. to 600° C. at a heating rate of 10° C./min and holding the temperature at 600° C. for 10 minutes in an argon gas stream of 300 mL/min to measure a resulting mass w2 of the sample, from which a first weight loss amount M1 is determined by formula (a1):
$$M 1 = ( w 1 - w 2 ) / w 1 \times 100 ; \qquad ( a1 )$$
(2) homogeneously mixing the measurement target, and precisely weighing out 0.0001 mg of the measurement target to prepare a sample, which is then burned under burning conditions described below, to quantify generated carbon dioxide using a CHN elemental analyzer, thereby determining a total carbon amount M3 (unit: % by mass) relative to the sample, wherein the burning conditions are as follows:
a combustion furnace temperature is 1150° C.,
a reduction furnace temperature is 850° C.,
a helium flow rate is 200 mL/min, and
an oxygen flow rate is 25 to 30 mL/min; and
(3) calculating Y by formula (a4):
$$Y = M 3 - M 1. \qquad ( a4 )$$

11. The positive electrode according to claim 2, wherein the positive electrode current collector main body has, on at least a part of its surface, a current collector coating layer having a thickness of 0.1 to 4.0 μm.

12. The positive electrode according to claim 2, wherein the positive electrode active material layer comprises a binder.

13. The positive electrode according to claim 2, wherein the positive electrode active material layer has a volume density of 2.00 to 2.80 g/cm³.

14. The positive electrode active material according to claim 2, wherein the positive electrode active material comprises a compound represented by a formula LifeₓM₍₁₋ₓ₎PO₄, wherein 0≤x≤1, M is Co, Ni, Mn, Al, Ti or Zr.

15. The positive electrode according to claim 14, wherein the positive electrode active material is lithium iron phosphate represented by LiFePO₄.

16. A non-aqueous electrolyte secondary battery, comprising the positive electrode of claim 2, a negative electrode, and a non-aqueous electrolyte disposed between the positive electrode and the negative electrode.

17. The non-aqueous electrolyte secondary battery according to claim 16, which has a volumetric energy density of 260 Wh/L or more.

18. A battery module or battery system comprising a plurality of the non-aqueous electrolyte secondary batteries of claim 16.

19. A method for producing the positive electrode of claim 2, comprising:
preparing a positive electrode composition comprising the positive electrode active material, and
coating the positive electrode composition on the positive electrode current collector,
wherein the composition preparing prepares the positive electrode composition without mixing the positive electrode active material with any of a conducting agent and a compound capable of turning into a conducting agent after the coating.
